(19) United States
(12) Patent Application Publication
(10) Pub. No.: US 2018/0118566 A1
(43) Pub. Date: May 3, 2018

(54) HYDROGEN SEPARATION MEMBRANE

(71) Applicants: Ravindra Datta, Worcester, MA (US); Pei-Shan Yen, Waltham, MA (US); Nicholas D. Deveau, Merrimack, NH (US)

(72) Inventors: Ravindra Datta, Worcester, MA (US); Pei-Shan Yen, Waltham, MA (US); Nicholas D. Deveau, Merrimack, NH (US)

(21) Appl. No.: 15/801,549

(22) Filed: Nov. 2, 2017

Related U.S. Application Data
(60) Provisional application No. 62/416,748, filed on Nov. 3, 2016.

(51) Int. Cl. C01B 3/50; B01D 71/02; B01D 53/22

(52) U.S. Cl. CPC C01B 3/503; B01D 69/04; B01D 53/228; B01D 71/022

(57) ABSTRACT

A hydrogen separation membrane employs a dense liquid metal separator deposited on a support structure for providing a membrane film allowing passage of hydrogen to be used in industrial processes and consumer applications benefiting from pure hydrogen. A support structure such as silicon carbide is non-reactive with the molten metal, thus withstanding the high temperatures associated with hydrogen producing processes. The liquid metal “wets”, or adheres/covers the support structure to form a continuous membrane for passing only hydrogen and resisting breakdown leading to discontinuity in the membrane surface. The molten (liquid) metal membrane is “sandwiched” between porous and inert ceramic supports to form a continuous thin film. Molecular hydrogen dissociates on the liquid metal membrane surface when exposed to a hydrogen gas mixture. The resulting hydrogen atoms dissolve into and diffuse across liquid metal film to arrive at the opposite surface, where they reassociate and desorb as pure hydrogen gas.

### RELATED APPLICATIONS:

This application claims the benefit under 35 U.S.C. § 119(e) of U.S. Provisional Patent Application No. 62/416,748, filed Nov. 3, 2016, entitled “HYDROGEN SEPARATION MEMBRANE,” incorporated herein by reference in entirety.

### STATEMENT OF FEDERALLY SPONSORED RESEARCH

This invention was made with government support under grant No. DE-FE0001050 awarded by the Department of Energy. The Government has certain rights in the Invention.

### BACKGROUND

Conventional approaches to hydrogen production are based largely on hydrocarbon reforming (or steam reforming) of fuels such as methane, methanol, or ethanol. There are three primary techniques used to produce hydrogen from hydrocarbon fuels: steam reforming (SR), partial oxidation (PDX), and autothermal reforming (ATR). Steam reforming is widely used in hydrogen production in industry with an efficiency about 70-85%. The reforming process produces a gas stream composed primarily of H₂, CO, CO₂ with trace H₂S. To further purify hydrogen from the stream, one or more water gas shift (WGS) stages are applied to reform CO into CO₂, followed by pressure swing adsorption (PSA) to separate hydrogen from mixed gas, mainly CO₂.

With the environmental concerns and inevitable depletion of fossil fuels becoming higher profile issues, the so-called “hydrogen economy” envisions widespread generation, storage, and usage of hydrogen as a clean and efficient energy vector, such as for fuel cell powered autos and grid electrical energy storage. While hydrogen is the most abundant element in the universe, on earth, it generally exists in a form combined with other elements, e.g., with oxygen as water, and with carbon as natural gas, or methane, or as hydrocarbons such as in gasoline, or with both oxygen and carbon as carbohydrates in biomass. Thus, reformation of these primary fuels is needed to produce hydrogen. In fact, virtually all of the hydrogen produced in the United States is through steam reforming, in which hydrocarbon fuels, such as natural gas, along with steam are converted into a mixture of carbon monoxide, carbon dioxide, and molecular hydrogen at a pressure of 25 atm. and a temperature of 800-950° C. Steam reforming is followed by water gas shift to produce a reformate gas (H₂+CO₂), from which H₂ is separated and purified typically via the energy-intensive pressure swing adsorption process.

### SUMMARY

A hydrogen separation membrane employs a liquid metal separator on a support structure for providing a continuous surface area for passage of hydrogen to be used in hydrocarbon reforming, fuel cells and other industrial processes benefiting from pure hydrogen. A support structure such as silicon carbide is non-reactive with the molten metal, thus withstanding the high temperatures associated with the steam reforming process. The molten metal is sandwiched between, or “wets”, and adheres/covers the support structure to form a continuous membrane for passing only hydrogen and resisting breakdown leading to discontinuity in the membrane film.

Configurations herein are based, in part, on the observation that industrial uses of hydrogen gas (H₂) are plentiful, and often rely on steam reformation, a resource and energy intensive process. Conventional approaches to hydrogen separation in these processes suffer from shortcomings in operating temperature, cost, complexity, and susceptibility to impurities. Alternate hydrogen purification approaches employing, for example, palladium (Pd), impose considerable expense. In contrast, configurations herein employ more common metals in a liquid (molten) state for providing high hydrogen permeability, thus allowing usage of Gallium (Ga) for example, at a cost that is substantially lower. The operating temperature range of palladium also limits usage, typically between 300°-550° C., while temperatures above 600° C. are common with steam reforming. Further, palladium is prone to poisoning, or contamination, by extraneous substances, most notably sulfur (S), which causes degradation after a relatively short usage interval, along with development of hairline cracks or defects allowing all gaseous components of the mixture to pass through. Accordingly, configurations herein substantially overcome the above-described shortcomings of conventional hydrogen separation by providing a molten (liquid) metal membrane “sandwiched” between porous and inert ceramic supports. Molecular hydrogen dissociates on the liquid metal membrane surface when exposed to a hydrogen gas mixture. The molten metal forms a film by “wetting” the ceramic support. The resulting hydrogen atoms dissolve into and diffuse across liquid metal film to arrive at the opposite surface, where they reassociate and desorb as pure hydrogen gas.

The disclosed hydrogen separator includes a support structure and a liquid metal membrane separator disposed on the support structure, such that the liquid metal membrane is configured for selective permeability to hydrogen, and in a particular configuration, selectively permeable to only hydrogen. The support structure is non-reactive with the liquid metal so as to not degrade in the presence of the molten metal or from the steam reforming operation. Thus, the support structure withstands the high temperatures involved with steam reforming operations of hydrocarbons, and does not react with the metal to form an alloy or an intermetallic compound, as would a metal support. In the disclosed configuration, thus, a ceramic support structure such as a silicon carbide support structure may be employed.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a hydrogen separation membrane as disclosed herein;

FIG. 2 shows a model of a hydrogen separator laboratory apparatus employing the membrane of FIG. 1; and

FIG. 3 shows hydrogen solubility for selection of membrane metals in the apparatus in FIG. 1 and FIG. 2; and

FIG. 4 shows a diagram of hydrogen bond strength of candidates for membrane metal selection in the apparatus of FIG. 1 and FIG. 2.

### DETAILED DESCRIPTION

Configurations below depict an example implementation of the disclosed layered or “sandwiched” liquid metal membranes for the selective separation and purification of hydrogen. The disclosed approach involves a thin film, around 200 microns, of a low melting (≤500° C.) metal or alloy that is sandwiched between two porous and inert ceramic supports. Molecular hydrogen dissociates on the liquid metal membrane surface exposed to a gas mixture including hydrogen. The hydrogen atoms dissolve into and diffuse across the liquid metal film to arrive at the opposite surface, where they reassociate and desorb as pure hydrogen gas. In contrast, a conventional hydrogen membrane is based on a thin film of solid palladium, or its alloy, on a porous support and operates on the same principle. The disclosed approach takes note that the solubility as well as diffusivity of atomic hydrogen in a liquid metal is higher than in solid metal membranes. Thus, disclosed configurations show that a molten metal membrane based on a liquid gallium film sandwiched between porous silicon carbide and/or graphite supports possesses a permeability at 500° C. that is roughly 35 times greater than that of palladium. Further, the liquid metals employed are cheaper and more abundant than palladium. In general, the liquid metal permeability medium has a higher hydrogen solubility and diffusivity than in a solid form of the permeability medium.

Conventional approaches employ thin (˜20 μm) but dense palladium membranes in a process that produces high purity H₂, along with concentrated CO₂ suitable for sequestration. However, Pd is expensive, sensitive to contaminants, and has limited stability at the temperatures employed (500° C. or higher) Consequently, cheaper and more abundant metals have also been investigated as H₂ membranes, but practical alternatives to Pd are lacking.

While some amorphous metals have attractive hydrogen permeability, they tend to become crystallized at the higher operating temperatures leading to permeability decay, and further often require a Pd surface coating to facilitate dissociative surface H₂ adsorption, typically the first step in hydrogen permeation.

Configurations disclosed and claimed herein demonstrate feasibility of a sandwiched liquid metal membrane (SLiMM) for H₂ purification. The liquid metal membrane overcomes many of the issues with conventional solid metal membrane usage such as sintering, hydrogen embrittlement, and thermal mismatch between the membrane and the support.

Configurations herein employ gallium as an example molten metal membrane. Although there are numerous other possible liquid metal/alloy candidates, gallium exhibits beneficial properties of a low melting point (29.8° C.), low cost, relative abundance, low toxicity, and very low vapor pressure making significant evaporation losses unlikely even over extended time at 500° C. Measured hydrogen permeability of liquid Ga at 500° C. is roughly 35 times higher than that of Pd, while its cost is approximately an order of magnitude lower. Development of such high performing and inexpensive membranes bring the H₂ economy a step closer to reality.

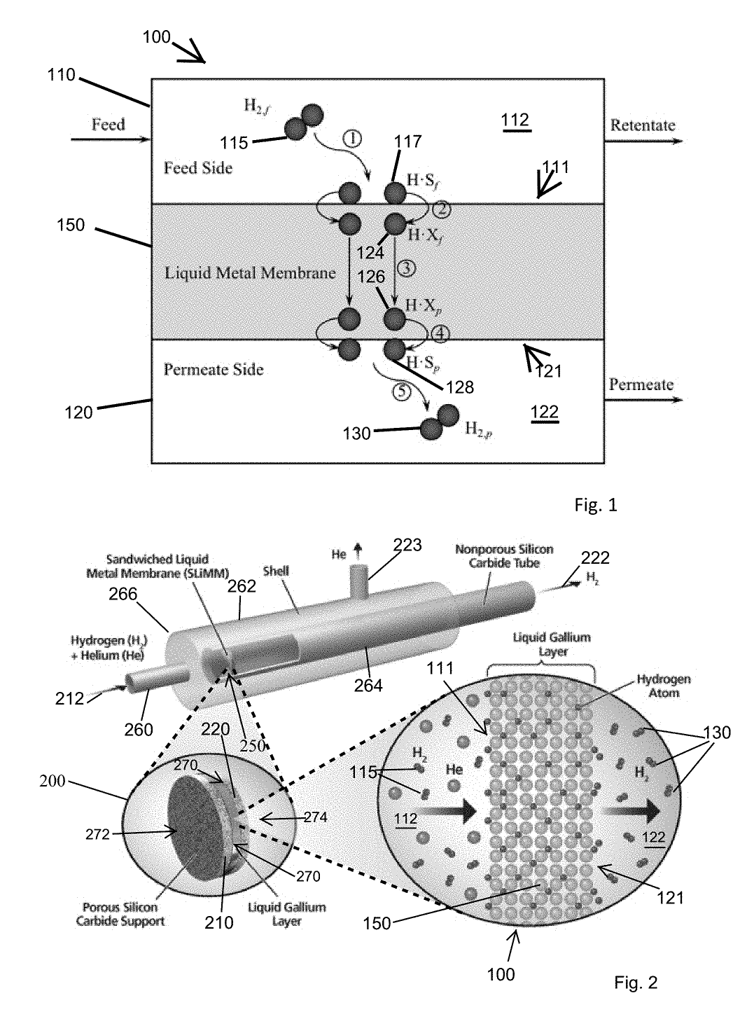

FIG. 1 is a schematic diagram of a hydrogen separation apparatus as disclosed herein. Referring to FIG. 1, a hydrogen separator apparatus 100 includes a hydrogen separator membrane 150. The hydrogen separator membrane 150 is defined by a liquid metal such as Ga, however other substances and compositions may be employed, based on hydrogen solubility and bonding energy considerations, as discussed below. The general approach comprises a thin (roughly, 200 μm) film of a liquid metal or alloy, sandwiched between two inert porous ceramic supports, discussed in FIG. 2 below. This film is thicker and therefore more robust than conventional Pd membranes, but provides good flux due to its higher permeability while ensuring robustness and denseness. As depicted in FIG. 1, a feed side 110 receives a gaseous mixture 112 including H₂. The hydrogen molecules 115 on the feed side 110 dissociatively adsorb on the metal surface 111 as H atoms 117. The hydrogen atoms 117 infiltrate the bulk lattice as interstitial H atoms 124, and diffuse across the membrane 150. Upon reaching the permeate side 120, the diffused hydrogen atoms 126 egress from the bulk metal to its surface 121, and finally the adsorbed H atoms 128 on the permeate side 122 metal surface recombine and desorb as H 2 molecules 130. The now pure hydrogen molecules 130 (hydrogen gas) defines the permeate from the membrane 150 for industrial use.

FIG. 2 shows a model of a hydrogen separator laboratory apparatus employing the membrane of FIG. 1. The membrane 150 of FIG. 1 is implemented in a manner to contain and support the liquid metal for hydrogen atom passage. Referring to FIGS. 1 and 2, the hydrogen separator 100 includes a support structure 200, with the liquid metal membrane 150 disposed on the support structure, in which the liquid metal membrane 150 is configured for selective permeability to hydrogen.

The full hydrogen separation membrane apparatus therefore includes two opposed porous surfaces 210, 220 defining a sandwich containment 250 adapted for retaining liquid. A liquid permeability medium defines the liquid metal membrane 150 disposed in the containment 250 and adapted for selective passage of a gaseous permeate such as hydrogen gas. A gaseous feed source 212 is in communication with the feed side 112 of the opposed porous surfaces 210, 220, and maintains a supply of hydrogen molecules at the feed side metal surface 111. The permeate side 122 of the opposed porous surfaces is defined by a pure form 222 of the gaseous permeate because the permeate side 122 receives a pure form of the gaseous permeate after membrane 150 passage.

In operation, a gaseous supply for hydrogen extraction or purification provides the gaseous fees source 212 via an input pipe 260 or tube. The tube 260 enters a shell vessel 262 that defines the feed side 112. Any suitable tank or closed container may be employed. A concentric internal tube 264 contains the support structure 200 near a proximate end 266 where it opens into the interior of the shell vessel 262. The proximate end 266 receives the gaseous feed source 212 adjacent to the containment structure 250. Alternate arrangements, for example, in planar configuration as shown in FIG. 1 can, of course, be readily conceived.

The physical apparatus including the encapsulated or containment of the liquid permeability medium includes vessels for transport of the gaseous feed, permeate, and retentate. The physical apparatus includes a receptacle, void or chamber to dispose a quantity of a gaseous mixture including hydrogen on the feed side 110, and permits hydrogen passage through the feed side porous surface 111 in a nonreactive manner. Reaction of the porous surface with the liquid metal, hydrogen or other intended permeate would, of course, compromise the quantity of the passed permeate. The permeate side 121 receives the hydrogen 128 on the surface of the permeability medium 150 for disassociation and adsorption. A vessel, void receptacle or chamber on the permeate side 122 collects the hydrogen on the permeate side following ingress into the lattice defined by the permeability medium and passage through the permeate side porous surface 122.

The physical containment may take a variety of suitable forms, however in the example arrangement the opposed porous surfaces 210, 220 each have containment facing sides 270 and outward facing sides 272, 274. The containment facing sides 270 encapsulate the permeability medium, which in the disclosed approach is the liquid metal membrane 150. The containment facing sides 270 sealably attach to an interior of the tube 264 for directing the gaseous feed 212 to the containment structure 250. The outward facing side 272 communicating with the gaseous feed source defines the feed side, and the outward facing side 274 demarcating the pure form hydrogen 130 defines the permeate side 122. Hydrogen 130 passing the membrane 150 forms the pure form 222 output, while the remainder (helium) is passed from the shell 262 through vessel 223. The porous surfaces 210, 220 permit passage of hydrogen or other molecular structure intended for passage through the membrane while retaining the permeability medium or the liquid metal film. The porous surfaces 210, 220 also permit passage of hydrogen at a rate at least as great as the permeability medium. The permeability medium defines a separation between the feed side 112 and permeate side 122 for providing exclusive fluid communication between the feed side 110 and the permeate side 120. In the example configuration, the porous surfaces are silicon carbide, while the tube 264 is non-porous to prevent inadvertent mixing or bypass of the feed and pure hydrogen sides.

The rationale for achieving higher permeance in the permeability medium may be understood within the framework of the so-called Sieverts law. The flux of hydrogen, N_{H}_{₂} (mol m⁻²s⁻¹), through a dense (solid or liquid) metal membrane is proportional to the difference of square root of p_{H}_{_{2′}}_{f}, the feed hydrogen partial pressure, and p_{H}_{_{2′}}ₚ, the permeate hydrogen partial pressure:

N_{H}_{₂}=P_{H}_{₂}({square root over (p_{H}_{_{2′}}_{f})}−{square root over (p_{H}_{_{2′}}ₚ)})

while the membrane permeance is shown in the following relation:

$${P}_{{H}_{2}} = ( \frac{1}{2 {V}_{M} \sqrt{{p}^{o}}} ) \frac{{K}_{S} {D}_{H}}{δ}$$

Here, V_{M} is the molar volume of the metal M, K_{S} is the Sieverts' equilibrium constant for the H₂ solution process, 1/2H₂+M⇄H·M, D_{H} is the interstitial diffusion coefficient of the hydrogen atoms, δ is the membrane thickness, and p^{o} is the standard pressure. In other words, permeance can be increased by increasing solubility K_{S} and the diffusivity of hydrogen atom, D_{H}. The factor 2 in the denominator accounts for interstitial diffusion of two H atoms per H₂ molecule. An alternate transport characteristic commonly used is membrane permeability P_{H}_{₂}, i.e.,

Q_{H}_{₂}=P_{H}_{₂}δ

which has the virtue of involving only material properties, not membrane thickness δ. The solubility of hydrogen in a metal is known to be described by Sieverts’ law,

$${x}_{H \cdot M} = {K}_{S} \sqrt{{p}_{{H}_{2} , f} / {p}^{o}} ; {K}_{S} = exp ( \frac{Δ {S}_{S}^{o}}{R} - \frac{Δ {H}_{S}^{o}}{RT} )$$

where the solubility x_{H·M} is the H/M mole fraction of interstitial H atoms in the metal M, and the Sieverts' equilibrium constant K_{S} as a function of temperature T is given in terms of ΔS_{S}^{o} and ΔH_{S}^{o}, the standard entropy and enthalpy change of hydrogen solution in the metal, respectively, and R is the gas constant.

Furthermore, the variation of the atomic H diffusion coefficient with temperature is given by:

$${D}_{H} = {D}_{H , 0} exp ( - \frac{{E}_{D}}{RT} )$$

where D_{H,o} is the pre-exponential factor, and E_{D} is an effective activation energy for diffusion.

Construction and selection of the porous surfaces and the permeability medium is based on the intended permeate and a diffusion rate, as computed above. The permeability medium has a predetermined thickness based on a desired permeance of hydrogen through the permeability medium. The feasibility of a liquid metal, and in particular liquid gallium, is shown with reference to conventional Pd as a solid metal membrane. Selection and construction (membrane film thickness) of the containment includes consideration of the solubility and diffusion coefficient of the intended permeate (hydrogen in the example configuration).

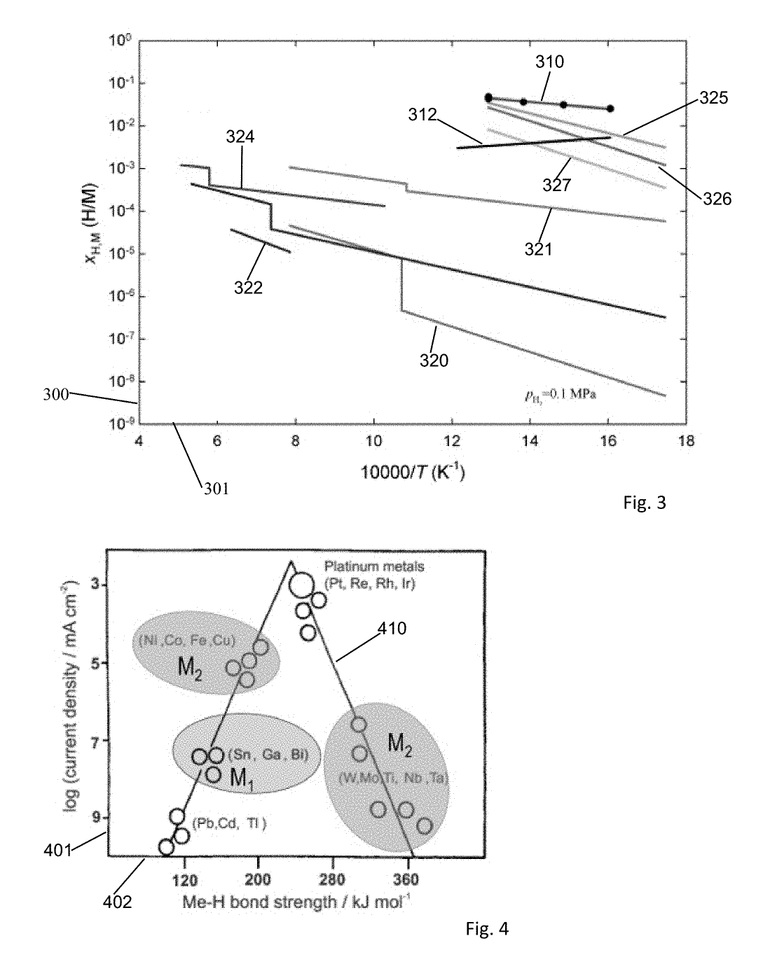

FIG. 3 shows hydrogen solubility x_{H·M} for selection of permeability medium materials or membranes in the apparatus in FIG. 2. In FIG. 3, the solubility 300 of hydrogen in various liquid and solid metals is shown versus inverse absolute temperature 301 for hydrogen pressure p_{H}_{₂}=0.1 MPa. In particular, the graphs for Ga 310 and Pd 312 are illustrative. The calculated heat of solution from the data in FIG. 3 provides ΔH_{S}^{o}=+15.76 kJ/mol while the entropy change is ΔS_{S}^{o}=−5.45 J/mol K. Thus, hydrogen solubility in liquid Ga is seen to be higher than that of Pd in the temperature range of interest (350-500° C.). Other graphs depict Al 320, Cu 321, Ag 322, Mg 323 and Ni 324, Li 325, K 326 and Na 327 in both solid and liquid form to show that there is a quantum jump in solubility of a metal upon melting. Most beneficial for use as the permeable membrane are substances that show increased interstitial space in the bulk metal upon melting in the range of temperatures of interest for practical applications.

In conventional approaches, thin Pd membranes (δ˜20 microns) are used to increase H₂ permeance and reduce costs. A further reduction in thickness is needed, however, to make Pd membranes cost-effective, which makes them less rugged. Thicker membranes, on the other hand, while being more robust and resistant to cracking or pin-hole formation, have a lower permeance, and thus require a larger membrane area A_{M} for a given hydrogen production rate, \dot{n}_{H}_{₂}=N_{H}_{₂}A_{M}. As an example, if membrane thickness δ is doubled, so must the membrane area A_{M}, thus quadrupling the amount (δ×A_{M}) and the cost of Pd that is needed. On the other hand, if one could double the permeability Q_{H}_{₂}, the thickness could be doubled to provide a more robust membrane without increasing its area, as occurs in the disclosed permeability membrane.

A particular feature of high permeability in the permeability membrane is that both the solubility x_{H·M} and the diffusion coefficient of hydrogen D_{H} in a liquid metal is higher than those in a solid metal by virtue of the typically greater amount of interstitial free space in a liquid rather than in a solid state of a metal, due to lowered density. This, in turn, results in a higher permeability Q_{H}_{₂} for hydrogen in the liquid metal. This feature is demonstrated with the example of a membrane fabricated from liquid gallium (Ga) metal in the disclosed approach.

FIG. 4 shows a diagram of hydrogen bond strength of metal candidates for membrane selection in the apparatus of FIG. 1 and FIG. 2. It follows that both the solubility x_{H·M} and the interstitial H atom diffusion coefficient D_{H} can be substantially higher, so that we may expect a substantially higher permeability Q_{H}_{₂}, in a liquid metal as compared to a solid metal. It is therefore beneficial to employ sandwiched dense liquid metal films as hydrogen membranes.

An appropriate liquid metal candidate for the permeability membrane may be selected according to the following characteristics:
1. a low melting point (≤500° C.), and a broad liquidus range, or low volatility;
2. adequate ability to activate hydrogen at the operating temperatures (˜500° C.);
3. low reactivity with other components in the has mixture such as CO, CO₂, and H₂O; and
4. It should preferably wet a porous support but not react with it.
   The dense liquid metal membrane is typically either a pure low melting (melting point≤500° C.) metal M, or an alloy comprised of two components: 1) a low-melting metal (M₁) to provide an open and fluid lattice (FIG. 4) desirable for ready dissolution and diffusion of hydrogen atoms, H; and 2) a non-precious group transition, or other catalytic, metal (M₂), to facilitate dissociation of hydrogen molecules at the membrane surface, in keeping with the accepted mechanism of hydrogen diffusion through a dense metallic membrane, wherein the H₂ molecule first dissociates and adsorbs on the surface (FIG. 2), followed by ingress into the lattice, and subsequent diffusion through it, both of which steps are presumably facilitated by lattice defects and vacancies present in a liquid metal film.

The choice of the catalytic metal (M₂) to improve H₂ dissociation is facilitated by the volcano plot 410 of hydrogen catalytic activity shown in FIG. 4, in which exchange current density 400 of the hydrogen electrode reaction is plotted versus the M-H bond strength 401, indicative of the first steps of the hydrogen permeation process in a dense membrane. As indicated in FIG. 4, M₁ candidates (e.g., Sn, Ga, Bi) may, of course, be alloyed with the precious group metals (PGMs), namely, Pt, Pd, Ru, Re, Rh, Os, and Jr, which would likely make excellent candidates for M₂. However, if an intention is to avoid the PGMs, one can focus on other transition metal catalysts that have the potential for activating H₂, i.e., the group Ni, Co, Cu, Fe, and Ag, as well as some of the early metals on the extreme right of FIG. 4, i.e., W, Mo, Nb, and Ta, as alloying with these may move the M-H binding energy of the membrane metal in the appropriate direction closer to the volcano peak. Thus, for example, Ga—Ag, Ga—Nb, Ga—Ti, Sn—Ag, or an In—Ni—Nb, system may be appropriate.

FIGS. 3 and 4 and accompanying discussion may be employed to derive trends regarding selection of liquid metal and alloy combinations. It stands that the permeability medium is a metal in a liquid state at the expected operating temperature (around 500° C.). It may also be a eutectic solution. In particular configurations, the permeability medium is selected from the group consisting of Ga, In, Cd, Sn and Bi, and may be an alloy of Sn, Ga or Bi. The alloy may also be formed from precious group metals selected from the group consisting of Pt, Pd, Ru, Re, Rh, Os, and Ir.

As with the permeability membrane, the support structure 200 benefits from appropriate selection of the porous surfaces 210, 220. The fabrication of a dense and stable sandwiched liquid metal membrane 150 is predicated on particular criteria for an appropriate porous support/diffusion-barrier layer:
1. A chemical inertness, as the molten metals are very reactive, and are likely to infiltrate the support at the elevated temperatures employed.
2. adequate wettability (preferable contact angle<100°) for the liquid metal to allow easy fabrication of a thin, dense, membrane.
3. adequate strength to allow compressive sealing, for both disk and tubular geometries, especially at the higher temperatures.
4. appropriate pore size and porosity.
   The largest support of pore radius r may be calculated for a desired trans-membrane pressure drop Δp to be withstood by the liquid membrane of surface tension γₗᵥ and contact angle θ via a rearranged form of the Young-Laplace equation, i.e.,

$$r = \frac{2 {γ}_{lv} cos θ}{Δ p}$$

For example, with gallium as the liquid metal, with γₗᵥ=708 mJ/m² and assuming say θ=100°, for a maximum trans-membrane pressure drop of 30 psi, the maximum pore radius, r=6 microns. Ceramic supports for such or smaller pore sizes can be readily obtained.

A particular criterion in the selection of an appropriate support is lack of reactivity of the support with the liquid metal, which are very reactive. Thus, most metal supports (except some refractory metals such as V) may not be suitable, readily forming alloys and intermetallic compounds with the liquid metals at higher temperatures. Many ceramics, on the other hand, are found to possess adequate inertness, e.g., SiC, TiN, Al₂O₃, ZrO₂, and numerous other ceramics comprising oxides, carbides, and nitrides. However, many of these porous materials are not adequately wetted owing to their inertness. For this reason, a sandwich configuration for the liquid metal membrane is beneficial, as shown schematically in FIG. 2.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A hydrogen separation membrane apparatus, comprising:
opposed porous surfaces defining a containment adapted for retaining a liquid layer,
a liquid permeability medium defining a membrane disposed in the containment and adapted for selective passage of a gaseous permeate,
a gaseous feed source in communication with a feed side of the opposed porous surfaces; and
a permeate side of the opposed porous surfaces defined by a pure form of the gaseous permeate, the permeate side receiving a pure form of the gaseous permeate after membrane passage.

2. The apparatus of claim 1 wherein the opposed porous surfaces each have containment facing sides and outward facing sides,
the containment facing sides encapsulating the permeability medium;
the outward facing side communicating with the gaseous feed source defining the feed side;
the outward facing side demarcating the pure form defining the permeate side.

3. The apparatus of claim 1 wherein the porous surfaces permit passage of hydrogen.

4. The apparatus of claim 1 wherein the porous surfaces permit passage of hydrogen at a rate at least as great as that in the permeability medium.

5. The apparatus of claim 1 wherein the permeability medium has a predetermined thickness based on a desired permeance of hydrogen through the permeability medium.

6. The apparatus of claim 1 wherein the permeability medium defines a separation between the feed side and permeate side for providing exclusive fluid communication between the feed side and the permeate side.

7. The apparatus of claim 2 further comprising:
a receptacle for a gaseous mixture including hydrogen on the feed side;
the feed side porous surface adapted to permit hydrogen passage in a nonreactive manner, and to receive the hydrogen on the feed side surface of the permeability medium for disassociation and adsorption;
a receptacle coupled to the permeate side porous surface for collecting the hydrogen on the permeate side following ingress into a lattice defined by the permeability medium and passage through the permeate side porous surface.

8. The apparatus of claim 1 wherein the permeability medium is a metal in a liquid state.

9. The apparatus of claim 1 wherein the permeability medium is a eutectic or alloy metal solution.

10. The apparatus of claim 1 wherein the permeability medium is selected from the group consisting of Ga, In, Cd, Sn and Bi.

11. The apparatus of claim 10 wherein the permeability medium is an alloy of a metal selected from the group consisting of Sn, Ga, Bi.

12. The apparatus of claim 11 wherein the alloy is formed from precious group metals selected from the group consisting of Pt, Pd, Ru, Re, Rh, Os.

13. The apparatus of claim 4 wherein the porous surfaces are ceramics comprising of various metal oxides, carbides, and nitrides.

14. The apparatus of claim 4 wherein the porous surfaces are silicon carbide or graphite.

15. A method for separating hydrogen from a gaseous mixture, comprising:
disposing opposed porous surfaces to define a containment adapted for retaining liquid, the porous surfaces defining a void therebetween based on an intended membrane thickness;
disposing a liquid permeability medium disposed in the containment, the liquid permeability medium defining a membrane adapted for selective passage of a gaseous permeate,
providing a gaseous feed source in communication with a feed side of the opposed porous surfaces; and
receiving a permeate defined by a pure form of the separated hydrogen from a permeate side of the opposed porous surfaces, the permeate side receiving a pure form of the gaseous permeate after membrane passage.

16. The method of claim 15 wherein the opposed porous surfaces each have containment facing sides and outward facing sides,
the containment facing sides encapsulating the permeability medium;
the outward facing side communicating with the gaseous feed source defining the feed side;
the outward facing side demarcating the pure form defining the permeate side.

17. The method of claim 15 wherein the permeability medium has a melting point below 500° C., has an ability to activate hydrogen substantially around 500° C., is substantially nonreactive with CO, CO₂ and H₂O, and is inert with respect to the opposed porous surface.

18. The method of claim 16 further comprising:
disposing a quantity of a gaseous mixture including hydrogen on the feed side;
permitting gas mixture passage through the feed side porous surface in a nonreactive manner;
receiving the hydrogen on a surface of the permeability medium for disassociation and adsorption;
collecting the hydrogen on the permeate side following ingress into a lattice defined by the permeability medium and passage through the permeate side porous surface.

19. The method of claim 18 wherein the permeability medium is a molecular or alloy form of metals selected from the group consisting of Ga, In, Cd, Sn and Bi.

20. A hydrogen separator comprising:
a ceramic support structure; and
a liquid metal membrane separator disposed on the support structure, the liquid metal membrane configured for selective permeability to hydrogen.

21. The apparatus of claim 11 wherein the alloy is formed from transition group metals selected from the group consisting of as Ni, Co, Cu, Fe, Ag, or early metals selected from the group consisting of W, Mo, Nb and Ta.
